(19) United States
(12) Patent Application Publication
(10) Pub. No.: US 2026/0292557 A1
(43) Pub. Date: Sep. 24, 2026

(54) METHOD AND APPARATUS FOR DETERMINING REFERENCE SIGNAL OF CANDIDATE CELL, AND STORAGE MEDIUM

(71) Applicant: Beijing Xiaomi Mobile Software Co., Ltd., Beijing (CN)

(72) Inventor: Xingyi LUO, Beijing (CN)

(21) Appl. No.: 19/490,846

(22) PCT Filed: Jun. 6, 2023
(86) PCT No.: PCT/CN2023/098709

§ 371 Date: Dec. 5, 2025

(51) Int. Cl. H04W 24/08; H04W 24/10

(52) U.S. Cl. CPC H04W 24/08; H04W 24/10

(57) ABSTRACT

The present disclosure relates to a method and apparatus for determining a reference signal of a candidate cell, and a storage medium. The method comprises: a network device sends first indication information, wherein the first indication information is used for indicating a reference signal of a candidate cell for which a terminal device needs to perform beam measurement. In this way, the terminal device can directly perform beam measurement on the reference signal of the corresponding candidate cell indicated by the network device, thereby solving the problems in the prior art of the large measurement time overhead and high complexity caused by a terminal device performing beam measurement on reference signals of all candidate cells configured for the terminal device.

### CROSS-REFERENCE TO RELATED APPLICATION

The present application is a U.S. National Stage of International Application No. PCT/CN2023/098709, filed on Jun. 6, 2023, the contents of all of which are incorporated herein by reference in their entirety for all purposes.

### BACKGROUND OF THE INVENTION

In a 3rd-generation partnership project (3GPP) radio access network (RAN), layer 1/layer 2 (L1/L2) based inter-cell mobility (LTM) is proposed. As shown in FIG. 1, a network device may maintain a plurality of candidate cells 1 for a terminal 2. As the terminal 2 moves, the terminal 2 may select one cell from the plurality of candidate cells 1 as a target cell 4 and then switch to the target cell 4, in a case where the terminal 2 needs to perform cell switching.

### SUMMARY OF THE INVENTION

The present disclosure relates to the technical field of communications, in particular to a method and device for determining a reference signal of a candidate cell, and a storage medium.

In a first aspect, a method for determining a reference signal of a candidate cell is provided. The method is performed by a network device and includes: sending first indication information, where the first indication information is configured to indicate a reference signal of a candidate cell for which a terminal needs to perform a beam measurement.

In a second aspect, a method for determining a reference signal of a candidate cell is provided. The method is performed by a terminal and includes: receiving first indication information, where the first indication information is configured to indicate a reference signal of a candidate cell for which the terminal needs to perform a beam measurement; and obtaining a beam measurement result by performing the beam measurement on the reference signal of the candidate cell indicated by the first indication information.

In a third aspect, a device for determining a reference signal of a candidate cell is provided. The device includes: a transceiver module configured to send first indication information, where the first indication information is configured to indicate a reference signal of a candidate cell for which a terminal needs to perform a beam measurement.

In a fourth aspect, a device for determining a reference signal of a candidate cell is provided. The device includes: a transceiver module configured to receive first indication information, where the first indication information is configured to indicate a reference signal of a candidate cell for which the terminal needs to perform a beam measurement; and a processing module configured to obtain a beam measurement result by performing the beam measurement on the reference signal of the candidate cell indicated by the first indication information.

In a fifth aspect, a communication device is provided. The communication device includes:
one or more processors; and
a memory storing processor-executable instructions;
where the one or more processors are configured to perform the steps of the method for determining the reference signal of the candidate cell provided by the first aspect of the present disclosure.

In a sixth aspect, a communication device is provided. The communication device includes:
one or more processors; and
a memory storing processor-executable instructions;
where the one or more processors are configured to perform the steps of the method for determining the reference signal of the candidate cell provided by the second aspect of the present disclosure.

In a seventh aspect, a non-transitory computer-readable storage medium is provided. The non-transitory computer-readable storage medium stores computer program instructions. The computer program instructions, when executed by one or more processors, implement the steps of the method for determining the reference signal of the candidate cell provided by the first aspect of the present disclosure.

In an eighth aspect, a non-transitory computer-readable storage medium is provided. The non-transitory computer-readable storage medium stores computer program instructions. The computer program instructions, when executed by one or more processors, implement the steps of the method for determining the reference signal of the candidate cell provided by the second aspect of the present disclosure.

In a ninth aspect, a communication system is provided. The communication system includes:
a network device, where the network device may perform the method for determining the reference signal of the candidate cell provided by the first aspect of the present disclosure; and
a terminal, where the terminal may perform the method for determining the reference signal of the candidate cell provided by the second aspect of the present disclosure.

### BRIEF DESCRIPTION OF DRAWINGS

FIG. 1 is a schematic diagram of communication of a terminal according to an example.

FIG. 2 is a schematic flowchart of cell switching according to an example.

FIG. 3 is a schematic structural diagram of a communication system according to an example.

FIG. 4 is a schematic structural diagram of a terminal according to an example.

FIG. 5 (a) and FIG. 5 (b) are schematic diagrams of two application scenarios according to an example.

FIG. 6 is a schematic flowchart of a method for determining a reference signal of a candidate cell according to an example.

FIG. 7 is a schematic flowchart of a method for determining a reference signal of a candidate cell according to another example.

FIG. 8 is a schematic diagram of a signaling format according to an example.

FIG. 9 is a schematic diagram of a signaling format according to another example.

FIG. 10 is a schematic diagram of a signaling format according to another example.

FIG. 11 is a schematic diagram of a signaling format according to another example.

FIG. 12 is a schematic diagram of a signaling format according to another example.

FIG. 13 is a schematic diagram of a signaling format according to another example.

FIG. 14 is a schematic structural diagram of a device for determining a reference signal of a candidate cell according to an example.

FIG. 15 is a schematic structural diagram of a device for determining a reference signal of a candidate cell according to another example.

FIG. 16 is a schematic structural diagram of a communication device according to an example.

### DETAILED DESCRIPTION OF THE INVENTION

Examples are illustrated in detail here, instances of which are represented in the accompanying drawings. When the following descriptions refer to the accompanying drawings, the same number in different accompanying drawings represents the same or similar elements unless otherwise indicated. The implementations described in the following examples do not represent all implementations consistent with the present disclosure. On the contrary, they are merely examples of a device and method consistent with some aspects of the present disclosure as detailed in the appended claims.

In the descriptions of the embodiments of the present disclosure, the used terms such as “first” and “second” are used for distinguishing similar objects, and need not be understood as a specific order or sequence. In addition, unless otherwise stated, in the description with reference to the accompanying drawings, the same symbol in different accompanying drawings represents the same element.

In the description of the embodiments of the present disclosure, unless otherwise stated, “plurality of” means two or more than two, and other quantifiers are similar to this. “At least one,” “one or more” or their similar expressions refer to any combination of these items, including any combination of single or plural items. For example, “at least one” may represent any quantity. For another example, “one or more of a, b, or c” may represent: a, b, c, a-b, a-c, b-c, or a-b-c, where each of a, b, and c may be a single element or a plurality of elements. “And/or” describes an association relationship of associated objects, which represents that there may be three kinds of relationships, for example, “A and/or B” may represent that there are three kinds of situations: A alone, A and B at the same time, and B alone, where A and B may be singular or plural. The character “/” indicates that associated objects in front of and behind it are in an “or” relationship. The singular forms “one,” “a,” “an item,” “this,” “said,” “above,” and “aforementioned” are intended to include the plural forms as well, unless the context clearly indicates other meanings.

In the description of the embodiments of the present disclosure, the recording methods such as “in one case A, in another case B,” and “in response to a case A, in response to another case B” may include the following technical solutions depending on the situations: A is performed independently of B, that is, in some embodiments, A; B is performed independently of A, that is, in some embodiments, B; A and B are selectively performed, that is, in some embodiments, A or B is selected to be performed; and A and B are both performed, that is, in some embodiments, A and B are selected to be performed. In a case where there are more branches such as A, B, and C, it is similar to the above.

In the description of the embodiments of the present disclosure, “including A,” “containing A,” “configured to indicate A” and “carrying A” may be interpreted as directly carrying A or indirectly indicating A.

In the description of the embodiments of the present disclosure, the terms such as “in response to . . . ,” “in response to determining . . . ,” “in a case of . . . ,” “at the time of . . . ,” “when . . . ,” “if . . . ” and “on condition that . . . ” may be interchangeable.

In some embodiments, the terms such as “network element,” “node,” “function,” “apparatus,” “device,” “system,” “chip,” and “system on chip” may be interchangeable.

In addition, each element, each row, or each column in the table of the embodiments of the present disclosure may be implemented as an independent embodiment, and a combination of any element, any row, or any column may also be implemented as an independent embodiment.

Although operations or steps are described in a specific order in embodiments or accompanying drawings of the present disclosure, it is not to be understood that these operations or steps need to be performed in the specific order or serial order shown, or all the operations or steps shown need to be performed to achieve desired results. In the embodiments of the present disclosure, these operations or steps may be performed in any sequence without conflict, or may be performed in parallel; or, a portion of these operations or steps may be performed; or the operations or steps in the plurality of embodiments or accompanying drawings may be arbitrarily combined, which is not limited to the embodiments of the present disclosure.

It needs to be noted that the embodiments of the present disclosure are not exhaustive and are merely an illustration of some embodiments, and do not serve as a specific limitation on the scope of protection of the present disclosure. In a case of no contradiction, each step in a certain embodiment may be implemented as an independent embodiment, and the steps may be combined arbitrarily. For example, the solution after removing some steps in a certain embodiment may also be implemented as an independent embodiment, and the order of each step in a certain embodiment may be exchanged arbitrarily. In addition, the optional implementations in a certain embodiment may be combined arbitrarily. Moreover, various embodiments may be combined arbitrarily. For example, some or all steps of different embodiments may be combined arbitrarily, and a certain embodiment may be combined arbitrarily with optional implementations of other embodiments.

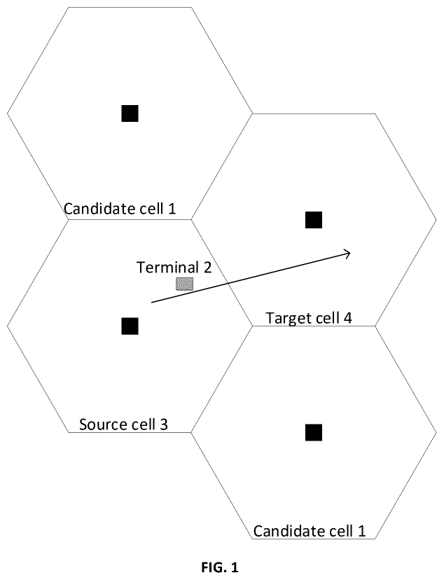

In a 3rd-generation partnership project (3GPP) radio access network (RAN), layer 1/layer 2 (L1/L2) based inter-cell mobility (LTM) is proposed. As shown in FIG. 1, a network device may maintain a plurality of candidate cells for a terminal. As the terminal moves, the terminal may select one cell from the plurality of candidate cells as a target cell and then switch to the target cell, in a case where the terminal needs to perform cell switching.

In LTM, in order to reduce a delay of the cell switching, the terminal performs L1 measurement on each candidate cell, and then determines whether the cell switching is currently needed according to an L1 measurement result for each candidate cell. However, in a case where the terminal performs the L1 measurement on all candidate cells configured for the terminal every time, it results in problems such as large measurement time overhead and high complexity.

In an example, embodiments of cell switching to which the present disclosure is applicable are introduced.

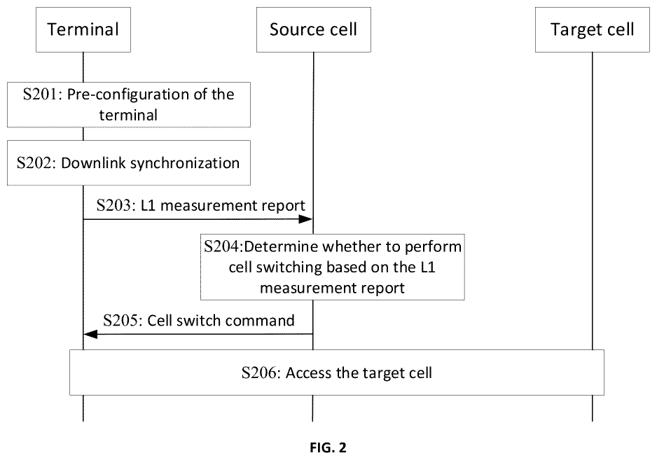

Please refer to FIG. 2, which is a schematic flowchart of cell switching according to an example. A process shown in FIG. 2 includes the following implementation steps S201 to S206.

In step S201, pre-configuration of a terminal is performed.

In an example, a network device may pre-configure/issue radio resource control (RRC) configuration parameters of a corresponding cell to the terminal through manners such as a signaling message. After receiving the RRC configuration parameters of the corresponding cell, the terminal may achieve a pre-configuration of the corresponding cell. For example, the RRC configuration parameters include a reference signal configuration, and the terminal may perform a beam measurement on a reference signal of a candidate cell indicated by the reference signal configuration based on the reference signal configuration.

In step S202, the terminal performs downlink (DL) synchronization.

In an example, the terminal may perform synchronization based on DL synchronization information sent by the network device. The DL synchronization information includes, but is not limited to, for example a main synchronization signal sequence, an auxiliary synchronization signal sequence, and a reference signal sequence issued by the network device, which is not limited in the present disclosure.

In step S203, the terminal sends an L1 measurement report to the network device.

The L1 measurement report is used for determining whether to perform the cell switching, where the L1 measurement referred to in the present disclosure is also known as beam measurement, and the L1 measurement report is also known as a beam measurement result. The beam measurement result may include, but is not limited to, an L1-RSRP, an L1-SINR, or other custom information of the cell. The L1-RSRP is reference signal receiving power (RSRP) sent by a corresponding cell beam, and the L1-SINR is a signal to interference plus noise ratio (SINR) of the reference signal sent by the corresponding cell beam on a terminal side. The cell switching herein may refer to switching a cell where the terminal currently resides (i.e., a serving cell, also known as a source cell) to another cell (i.e., a target cell). The target cell is a cell selected from candidate cells adjacent to the serving cell.

In step S204, the source cell determines whether to perform the cell switching based on the L1 measurement report.

In step S205, the source cell sends a cell switch command to the terminal.

The source cell of the network device may judge whether to perform the cell switching based on the L1 measurement report. For example, in a case where the L1 measurement result for a certain candidate cell is better than the L1 measurement result for the current serving cell, or the L1 measurement result for a certain candidate cell is greater than a certain threshold, it may be determined that the cell switching needs to be performed, and the candidate cell may be used as the target cell. When it is determined that the cell switching needs to be performed, the source cell may send a cell switch command to the terminal to trigger the terminal to switch from the source cell to the target cell. The cell switch command is configured to indicate/trigger the terminal to switch from the source cell to the target cell.

In step S206, the terminal accesses the target cell.

Correspondingly, after receiving the cell switch command, the terminal may switch the source cell to the target cell in response to the cell switch command.

In an example, some system and scenario embodiments to which the present disclosure is applicable are introduced below.

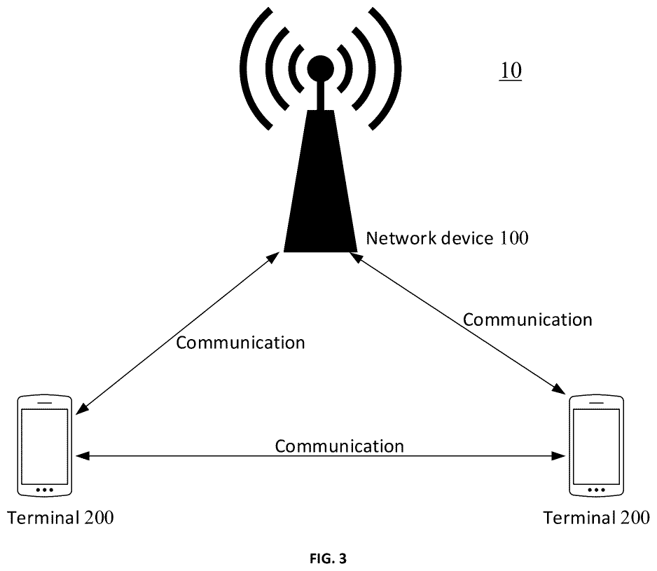

Please refer to FIG. 3, which is a schematic structural diagram of a communication system according to an example. The communication system 10 shown in FIG. 3 includes a network device 100 and a terminal 200. The present disclosure does not limit the quantity of the network devices 100 and the terminals 200. The illustration shows one network device 100 and two terminals 200 as an example, but does not constitute a limitation. Any two terminals 200 in the present disclosure may communicate with each other through a network, and the network device 100 and the terminals 200 may also communicate with each other through a network, which is not limited to the present disclosure. Data transmission from the network device 100 to the terminal 200 is called downlink data transmission, and data transmission from the terminal 200 to the network device 100 is called uplink data transmission.

The system in the present disclosure may be applied to various communication systems, such as a 5th generation (5G) system or new radio (NR), a long-term evolution (LTE) system, an LTE frequency division duplex (FDD) system, an LTE time division duplex (TDD), and future communication systems. The future communication systems include, but are not limited to, a 6th generation mobile communication system, a satellite communication system, etc.

The network device 100 in the present disclosure may be a base station, an evolved node B (eNB), a femto, an access point (AP) in a wireless fidelity (WIFI) system, a wireless relay node, a wireless backhaul node, a transmission point (TP), or a transmission and reception point (TRP), etc. The network device 100 may further be a gNB in an NR system. Alternatively, the network device 100 may further be a component that constitutes the base station or part of the device, such as a central unit (CU), a distributed unit (DU), or a baseband unit (BBU).

The network device 100 in the present disclosure may have one or more cells with resources for communicating with the terminal 200. The cells may have a separate, overlapping, or partially overlapping coverage area. Each cell may be identified/distinguished using a physical cell identifier (PCI) to identify the cell to the terminal 200. A cell where the terminal 200 currently communicates with the network device 100 may be referred to as the serving cell, and other cells adjacent to the serving cell may be referred to as candidate cells. That is to say, a communication cell where the terminal 200 is currently located is referred to as the serving cell, and other cells adjacent to the serving cell are referred to as the candidate cells.

The terminal 200 in the present disclosure may be fixed or mobile. FIG. 3 is merely a schematic diagram. The communication system 10 may also include other network devices, such as a wireless relay device and a wireless backhaul device, which are not drawn in FIG. 3. The embodiments of the present disclosure do not limit the types and quantities of the network devices 100 and the terminals 200 included in the communication system 10.

The terminal 200 may also be referred to as a terminal, user equipment (UE), a mobile station (MS), a mobile terminal (MT), etc.

The terminal 200 in the embodiments of the present disclosure may be a mobile phone, a Pad, and a computer with a wireless transceiving function, and may further be a wireless terminal applied in scenarios such as virtual reality (VR), augmented reality (AR), industrial control, self-driving, remote medical, a smart grid, transportation safety, a smart city, and a smart home. In the present disclosure, the aforementioned terminal and the chip capable of being applied to the aforementioned terminal are collectively referred to the terminal. It is to be understood that the specific technology and the specific device form used by the terminal 200 are not limited in the embodiments of the present disclosure.

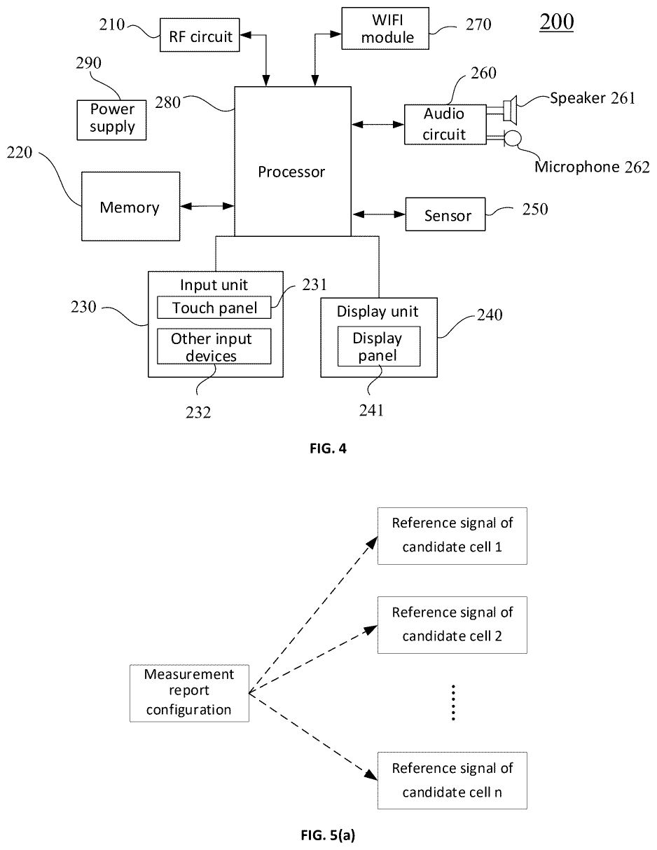

Please refer to FIG. 4, which is a schematic structural diagram of a terminal according to an example. The terminal 200 shown in FIG. 4 may include components such as a radio frequency (RF) circuit 210, a memory 220, an input unit 230, a display unit 240, a sensor 250, an audio circuit 260, a wireless fidelity (WiFi) module 270, a processor 280, and a power supply 290. Those skilled in the art may understand that a device structure shown in FIG. 4 constitutes no limitation on the terminal 200, and the terminal 200 may include more or fewer components than those shown in the figure, or combine some components, or use different component arrangements.

Various constituent components of the terminal 200 are introduced below in detail with reference to FIG. 4.

The RF circuit 210 may be used for receiving and sending of signals during information transceiving or during a call. Specifically, the RF circuit 210 receives downlink information from a base station and forwards the downlink information to the processor 280 for processing. Additionally, the RF circuit 210 sends uplink data to the base station. Generally, the RF circuit 210 includes, but is not limited to, an antenna, at least one amplifier, a transceiver, a coupler, a low noise amplifier (LNA), a duplexer, and the like. In addition, the RF circuit 210 may further communicate with the network and other devices through wireless communication. The wireless communication may use any communication standard or protocol, including but is not limited to a global system of mobile communication (GSM), a general packet radio service (GPRS), a code division multiple access (CDMA), a wideband code division multiple access (WCDMA), a long term evolution (LTE), an email, a short messaging service (SMS), etc.

The memory 220 may be configured to store software programs and modules, and the processor 280 performs various functional applications and data processing of the terminal by running the software programs and the modules stored in the memory 220. The memory 220 may mainly include a program storage area and a data storage area. The program storage area may store an operating system, an application program required by at least one function (such as a sound playback function and an image playback function), etc. The data storage area may store data (such as audio data and a phone book) created according to the usage of the terminal. In addition, the memory 220 may include a high-speed random access memory, and may also include a non-volatile memory, such as at least one disk storage device, a flash memory device, or other volatile solid-state storage devices.

The input unit 230 may be used for receiving input numerical or character information, and generating key signal inputs related to user settings and function controls of the terminal 200. Specifically, the input unit 230 may include a touch panel 231 and other input devices 232. The touch panel 231, also known as a touch screen, may collect user touch operations (such as user operations on or near the touch panel 231 by using any suitable object or accessory such as fingers and stylus) on or near the touch panel 231, and drive corresponding connection devices according to a pre-set program. In an example, the touch panel 231 may include two parts: a touch detection device (not shown) and a touch controller (not shown). The touch detection device detects a touch direction of the user, detects a signal brought by the touch operation, and transmits the signal to the touch controller. The touch controller receives touch information from the touch detection device, converts the touch information into touch point coordinates, and sends the touch point coordinates to the processor 280, and can receive a command sent from the processor 280 and execute the command. In addition, the touch panel 231 may be implemented using various types such as resistive, capacitive, infrared, and surface acoustic waves. In addition to the touch panel 231, the input unit 230 may further include other input devices 232. The other input devices 232 may include, but are not limited to, one or more of a physical keyboard, a functional key (such as a volume control key and a switch key), a track ball, a mouse, and a joystick.

The display unit 240 may be used for displaying information input by the user or information provided to the user, and various menus of the terminal 200. The display unit 240 may include a display panel 241. In an example, the display panel 241 may be configured in a form of a liquid crystal display (LCD), an organic light-emitting diode (OLED), or the like. Further, the touch panel 231 may cover the display panel 241. In a case where the touch panel 231 detects a touch operation on or near the touch panel 231, the touch panel 231 transmits the touch operation to the processor 280 to determine a type of a touch event, and then the processor 280 provides corresponding visual output on the display panel 241 according to the type of the touch event. Although in FIG. 4, the touch panel 231 and the display panel 241 are used as two independent components to implement the input and output functions of the terminal 200, in some embodiments, the touch panel 231 and the display panel 241 may be integrated to achieve the input and output functions of the terminal 200.

The terminal 200 may further include at least one sensor 250, such as a light sensor, a motion sensor, and other sensors. The light sensor may include an ambient light sensor and a proximity sensor. The ambient light sensor may adjust a brightness of the display panel 241 according to the brightness of ambient light, and the proximity sensor may turn off at least one of the display panel 241 or backlight in a case where the terminal 200 is moved to the ear. As a type of the motion sensor, an accelerometer sensor may detect the magnitude of acceleration in various directions (usually three-axis), may detect the magnitude and direction of gravity when stationary, and may be used for applications for recognizing terminal posture (such as horizontal and vertical screen switching, related games, and magnetometer posture calibration), vibration recognition related functions (such as a pedometer and tapping), etc. Other sensors that can be configured on the terminal 200, such as a gyroscope, a barometer, a hygrometer, a thermometer, and an infrared sensor, are not repeated herein.

The audio circuit 260, a speaker 261, and a microphone 262 may provide audio interfaces between the user and the terminal 200. The audio circuit 260 may transmit electrical signals converted from received audio data to the speaker 261, and the speaker 261 then converts them into sound signals for outputting. The microphone 262 converts the collected sound signals into electrical signals, and the electrical signals are received by the audio circuit 260 and converted into audio data. The audio data is then outputted to the processor 280 for processing and then sent to, for example, another terminal through the RF circuit 210, or the audio data is outputted to the memory 220 for further processing.

WiFi belongs to a short-range wireless transmission technology. The terminal 200 may help the user to transceive e-mail, browse web pages and access streaming media through a WiFi module 270, and the WiFi module 270 provides the user with wireless broadband Internet access. Although FIG. 4 shows the WiFi module 270, it may be understood that the WiFi module 270 is not a necessary component of the terminal 200 and may be omitted as needed without changing the essence of the invention.

The processor 280 is a control center of the terminal 200, and connects various parts of the entire terminal 200 through various interfaces and lines. By running or executing the software programs and/or the modules stored in the memory 220, as well as calling data stored in the memory 220, the processor 280 executes various functions of the terminal 200 and processes data, so as to perform overall monitoring on the terminal 200. In an example, the processor 280 may include one or more processing units. In an example, the processor 280 may integrate an application processor and a modem processor, where the application processor mainly processes an operating system, a user interface, an application program and the like, and the modem processor mainly processes wireless communication. It may be understood that the modem processor may also not be integrated into the processor 280.

The terminal 200 may further include the power supply 290 (such as a battery) for supplying power to the various components. The power supply 290 may be logically connected with the processor 280 through a power supply management system (not shown), so that functions such as charging, discharging, and power consumption management are implemented through the power supply management system. Although not shown, the terminal 200 may also include devices such as a camera and Bluetooth module, which is omitted herein.

In an example, a plurality of possible application scenarios to which the present disclosure is applicable are introduced first below.

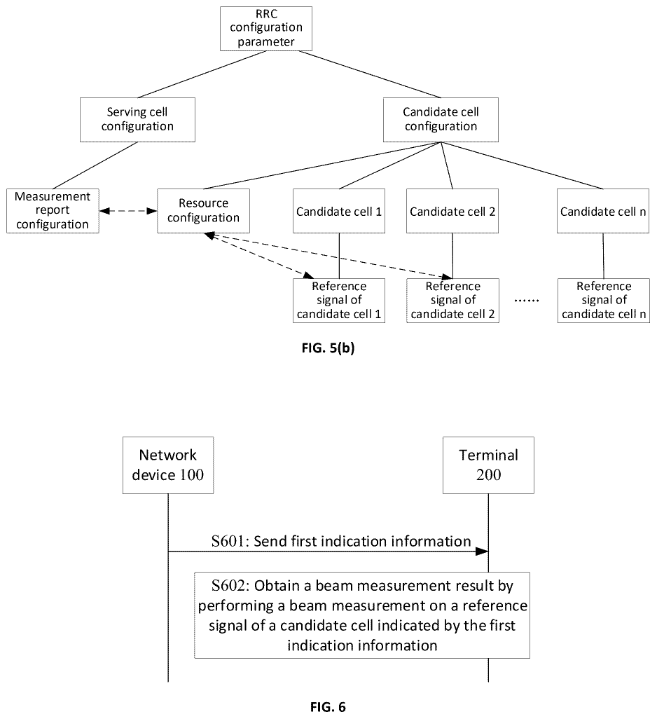

Please refer to FIG. 5(a), which is a schematic diagram of an application scenario according to an example. As shown in FIG. 5(a), the network device 100 pre-configures a reference signal of at least one candidate cell for the terminal 200. In some embodiments, when configuring a measurement report configuration (Reportconfig) for the terminal 200, the network device 100 associates the measurement report configuration with the reference signal of the at least one candidate cell. The present disclosure does not limit the quantity of associated candidate cells, which may be determined according to actual situations. The illustration shows reference signals of n candidate cells associated as an example, but does not constitute a limitation. n may be a positive integer determined according to actual situations.

Further, the network device 100 may send the measurement report configuration and the reference signals of the candidate cells associated with the measurement report configuration to the terminal 200 through corresponding indication information or signaling. Correspondingly, after receiving the indication information/signaling, the terminal 200 may perform the beam measurement on the reference signal of each candidate cell associated with the measurement report configuration. In an example, after receiving the indication information/signaling, the terminal 200 may not perform any beam measurements until the terminal 200 receives other indication information/signaling.

Please refer to FIG. 5(b), which is a schematic diagram of an application scenario according to another example. As shown in FIG. 5(b), the network device 100 pre-configures a reference signal of at least one candidate cell for the terminal 200. In some embodiments, when configuring a measurement report configuration (Reportconfig) for the terminal 200, the network device 100 associates the measurement report configuration with the reference signal of the at least one candidate cell. The network device 100 may dynamically change the configuration association through corresponding indication information/signaling, so as to indicate/send the reference signal of each candidate cell for which the terminal 200 needs to perform the beam measurement to the terminal 200.

In some embodiments, the network device 100 performs corresponding configurations for a serving cell and each candidate cell in LTM in RRC configuration parameters. As shown in the figure, the RRC configuration parameters include a serving cell configuration (serving cell config) and a candidate cell configuration (candidate cell config). The candidate cell configuration includes at least one candidate cell. The present disclosure does not limit the quantity of the candidate cells. The illustration shows n candidate cells as an example, but does not constitute a limitation. Each candidate cell may be associated with a corresponding reference signal or reference signal resource set (RSlist for candidate cell). The RRC configuration parameters may further include a measurement report configuration (Reportconfig) and a resource configuration (Resourceconfig). The measurement report configuration is configured to indicate to report a result of beam measurement performed by the terminal 200 on the candidate cells, such as reporting a number of beams, reporting a type and a resource to which the measurement report configuration belongs (which can be referred to as a reporting type and a reporting resource), or other custom information. The resource configuration contains/is associated with the reference signal or the reference signal resource set of at least one candidate cell. The resource configuration is configured to indicate the reference signals associated with the measurement report configuration, such as the reference signal of any candidate cell, which is not limited to the present disclosure.

Correspondingly, after receiving the indication information/signaling, the terminal 200 may perform the beam measurement on the reference signal of each candidate cell indicated by the indication information/signaling and needing to be subjected to the beam measurement.

Based on the above embodiments, in LTM, in order to solve the problems such as high time overhead and high complexity caused by the terminal 200 performing the L1 measurements on all candidate cells configured for the terminal 200 each time, the solution proposed in the present disclosure can dynamically indicate/select the reference signals of the candidate cells that need to be measured for the terminal, so as to reduce the time overhead and complexity of measurement.

Please refer to FIG. 6, which is a schematic flowchart of a method for determining a reference signal of a candidate cell according to an example. The method shown in FIG. 6 is applied to a communication system, and the method includes the implementation steps S601 and S602.

In step S601, the network device 100 sends first indication information to the terminal 200, where the first indication information is configured to indicate a reference signal of a candidate cell for which the terminal 200 needs to perform a beam measurement. Correspondingly, the terminal 200 receives the first indication information.

The present disclosure does not limit the quantity of the candidate cells, which may be one or more, and the specific quantity may be determined according to the actual situations. The present disclosure does not limit the quantity and types of the reference signals. The reference signal refers to a reference signal that may be subjected to the beam measurement or reflect corresponding beam information. The reference signal may include, but is not limited to, any one or a combination of the following: a synchronization signal and PBCH block (SSB), a channel state information reference signal (CSI-RS), or other reference signals.

In an embodiment, the first indication information may be carried in any of the following types of signaling: downlink control information (DCI) signaling, or medium access control (MAC) control element (MAC CE) signaling. The present disclosure does not limit the sending manner of the first indication information. In another embodiment, the present disclosure may carry the first indication information by introducing new signaling (for example, the network device may customize and select corresponding dynamic signaling, which may be referred to as dynamic signaling or selection signaling), so as to indicate the reference signal of the candidate cell for which the terminal 200 needs to perform a beam measurement.

In step S602, the terminal 200 obtains a beam measurement result by performing the beam measurement on the reference signal of the candidate cell indicated by the first indication information.

After receiving the first indication information, the terminal 200 may obtain the beam measurement result for corresponding candidate cell by performing the beam measurement on the reference signal of the corresponding candidate cell indicated by the first indication information based on the first indication information. The beam measurement result is used for determining whether to switch to this candidate cell, that is, the beam measurement result is used for determining whether to switch a serving cell where the terminal 200 is currently located to this candidate cell. For example, in a case where the beam measurement result for the candidate cell indicates that a signal quality strength of the candidate cell is high (such as greater than a preset strength), cell switching may be allowed. Specifically, the serving cell where the terminal 200 is currently located may be switched to the candidate cell.

The beam measurement result may also be referred to as a Layer 1 (L1) measurement result, which may include, but is not limited to, an L1-RSRP, an L1-SINR, or other custom information of the candidate cell. For the relevant introduction of the beam measurement result, reference may be correspondingly made to the relevant introduction in the embodiment described in FIG. 2, which is omitted here.

By implementing the embodiment of the present disclosure, the network device 100 sends the first indication information, and the first indication information is configured to indicate the reference signal of the candidate cell for which the terminal needs to perform the beam measurement. Correspondingly, the terminal 200 receives the first indication information, and then may obtain the beam measurement result by performing the beam measurement on the reference signal of the candidate cell indicated by the first indication information. In this way, the terminal 200 merely needs to perform the beam measurement on the reference signals of the corresponding candidate cells indicated by the network device 100, instead of performing the beam measurement on the reference signals of all the candidate cells configured for the terminal 200. This is beneficial to save time overhead of the beam measurement and reduce measurement complexity.

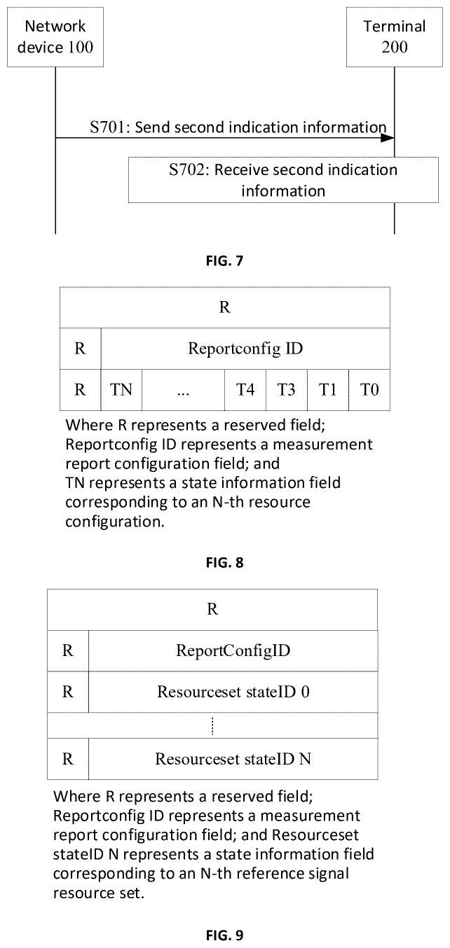

Please refer to FIG. 7, which is a schematic flowchart of a method for determining a reference signal of a candidate cell according to another example. The method shown in FIG. 7 is applied to the communication system, and the method includes the implementation steps S701 and S702.

In step S701, the network device 100 sends second indication information to the terminal 200, where the second indication information is configured to indicate a measurement report configuration pre-configured for the terminal and a reference signal of at least one candidate cell associated with the measurement report configuration.

In step S702, the terminal 200 receives the second indication information sent by the network device 100.

In practical applications, the network device 100 pre-configures the reference signal of the at least one candidate cell for the terminal 200 before sending the first indication information, where the reference signal may include a reference signal of a serving cell where the terminal 200 is currently located. In the implementation process, when configuring the corresponding measurement report configuration (Reportconfig) for the terminal 200, the network device 100 may associate the measurement report configuration with the reference signal of the at least one candidate cell, that is, the measurement report configuration may be associated with the reference signal of the candidate cell for which the beam measurement needs to be performed. Correspondingly, the network device 100 may send the second indication information (or indication signaling) to the terminal 200 to inform the terminal 200 of the measurement report configuration pre-configured by the network device 100 for the terminal 200 and the reference signals of all the candidate cells associated with the measurement report configuration.

Correspondingly, after receiving the second indication information, the terminal 200 may perform the beam measurement on the reference signals of all the candidate cells associated with the measurement report configuration indicated in the second indication information. Alternatively, the terminal 200 may also wait for the network device 100 to issue the first indication information, and does not perform the beam measurement on the reference signal of any candidate cell before receiving the first indication information.

Some possible optional embodiments are introduced below with reference to the embodiments described in FIG. 6 and FIG. 7.

The indication manner of the first indication information may vary in different application scenarios. Firstly, the indication manner of the first indication information in the application scenario shown in FIG. 5(a) is introduced. In this application scenario, the first indication information may directly indicate the reference signal of the candidate cell for which the terminal 200 needs to perform the beam measurement.

In some embodiments, in a case where the measurement report configuration is associated with a plurality of resource configurations, the first indication information may include an identifier for indicating the measurement report configuration (or, may include the identifier of the measurement report configuration (Reportconfig ID)), and state information (Resourceconfig stateID) respectively corresponding to each resource configuration associated with the measurement report configuration. In this case, one resource configuration is correspondingly associated with one reference signal resource set (Resourceset), and one reference signal resource set includes a reference signal of one candidate cell. The present disclosure does not limit the quantity and type of the reference signal. For example, the reference signal resource set may include SSB, CSI-RS, or other reference signals of the candidate cell. The state information corresponding to the resource configuration is configured to indicate whether to perform the beam measurement on the reference signal resource set (it may specifically be the reference signals of the candidate cells in the reference signal resource set) associated with the resource configuration.

The present disclosure does not limit the form of representation of the state information, and the state information may be represented in a form of numbers, letters, characters, or their combinations. For example, in a case where the state information corresponding to the resource configuration is a first state (such as 0/1), the state information may be configured to indicate/represent that the terminal 200 needs to perform the beam measurement on the reference signal resource set associated with the resource configuration. In a case where the state information corresponding to the resource configuration is a second state (such as 1/0), the state information may be configured to indicate/represent that the terminal 200 does not need to perform the beam measurement on the reference signal resource set associated with the resource configuration.

The present disclosure does not limit the order in which the state information respectively corresponding to each resource configuration is arranged. For example, the state information corresponding to each resource configuration may be arranged in a preset order (such as in descending order of the identifier) according to the identifier (Resourceset ID) of each corresponding reference signal resource set. The present disclosure also does not limit the quantity of the state information corresponding to the resource configurations, and the quantity may be determined according to actual communication needs. For example, the first indication information may include the state information respectively corresponding to each resource configuration associated with the measurement report configuration. Alternatively, the first indication information may also include state information corresponding to a target resource configuration associated with the measurement report configuration and used for instructing the terminal 200 to perform the beam measurement. That is to say, the first indication information merely includes the state information corresponding to partial resource configurations used for instructing the terminal 200 to perform the beam measurement, such as merely the state information corresponding to the resource configuration with a value of 0/1, which is not excessively limited and described in detail in the present disclosure.

In practical applications, the first indication information in the present embodiment may be carried in first signaling for transmission. Please refer to FIG. 8, which is a schematic diagram of a signaling format according to an example. The signaling shown in FIG. 8 may include a measurement report configuration field (Reportconfig ID) and a respective state information field (Resourceconfig state ID, abbreviated as the state information field, represented as T in the diagram) for at least one resource configuration. In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The measurement report configuration field is used for carrying an identifier of the measurement report configuration. The state information fields are used for carrying state information corresponding to the corresponding resource configurations, and the resource configurations refer to resource configurations managed by the measurement report configuration, namely, resource configurations associated with the measurement report configuration. The present disclosure does not limit the quantity of the state information fields, and the quantity may be determined according to actual situations. The illustration shows N state information fields (TN) as an example, but does not constitute a limitation. N is a positive integer determined according to actual situations.

In some other embodiments, in a case where the measurement report configuration is associated with a plurality of reference signal resource sets (Resourceset ID), the first indication information may include an identifier (Reportconfig ID) for indicating the measurement report configuration, and state information (Resourceset stateID) respectively corresponding to each reference signal resource set associated with the measurement report configuration. One reference signal resource set includes a reference signal of one candidate cell. The state information corresponding to the reference signal resource set is configured to indicate whether to perform the beam measurement on the reference signal resource set (it may specifically be the reference signals of the candidate cells in the reference signal resource set). For the introduction of the reference signal resource set, reference may be correspondingly made to the relevant introduction in other embodiments, which is omitted here.

The present disclosure does not limit the form of representation of the state information, and the state information may be represented in a form of numbers, letters, characters, or their combinations. For example, in a case where the state information corresponding to the reference signal resource set is a third state (such as 0/1), the state information may be configured to indicate/represent that the terminal 200 needs to perform the beam measurement on the reference signal resource set. In a case where the state information corresponding to the reference signal resource set is a fourth state (such as 1/0), the state information may be configured to indicate/represent that the terminal 200 does not need to perform the beam measurement on the reference signal resource set. In an example, the present disclosure does not limit the order in which the state information corresponding to each reference signal resource set is arranged. For example, the state information corresponding to each reference signal resource set may be arranged in a preset order (such as in descending order of the identifier) according to the identifier (Resourceset ID) of each reference signal resource set.

The present disclosure also does not limit the quantity of the state information corresponding to the reference signal resource sets, and the quantity may be determined according to actual communication needs. For example, the first indication information may include the state information respectively corresponding to each reference signal resource set associated with the measurement report configuration. Alternatively, the first indication information may also include state information corresponding to a target reference signal resource set associated with the measurement report configuration and used for instructing the terminal 200 to perform the beam measurement. That is to say, the first indication information merely includes the state information corresponding to partial reference signal resource sets used for instructing the terminal 200 to perform the beam measurement, such as merely the state information corresponding to the reference signal resource set with a value of 0/1, which is not excessively limited and described in detail in the present disclosure.

In practical applications, the first indication information in the present embodiment may be carried in second signaling for transmission. Please refer to FIG. 9, which is a schematic diagram of a signaling format according to another example. The signaling shown in FIG. 9 may include a measurement report configuration field (Reportconfig ID) and a respective state information field (Resourceset state ID) for at least one reference signal resource set. In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The measurement report configuration field is used for carrying an identifier of the measurement report configuration. The state information fields for the reference signal resource sets are used for carrying state information corresponding to the reference signal resource sets, and the reference signal resource sets refer to reference signal resource sets managed by the measurement report configuration, namely, reference signal resource sets associated with the measurement report configuration. The present disclosure does not limit the quantity of the state information fields for the reference signal resource sets, and the quantity may be determined according to actual situations. The illustration shows state information fields (Resourceset stateID N) for N reference signal resource sets as an example, but does not constitute a limitation. N is a positive integer determined according to actual situations.

In some other embodiments, in a case where the resource configuration is associated with a plurality of reference signal resource sets, the first indication information may include an identifier (Resourceconfig ID) of one resource configuration, and state information (Resourceset stateID) respectively corresponding to each reference signal resource set associated with the resource configuration. In this case, one resource configuration is correspondingly associated with at least one reference signal resource set, and one reference signal resource set includes a reference signal of one candidate cell. The present disclosure does not limit the quantity of the resource configurations included in the first indication information. In a case where there is at least one resource configuration, the first indication information includes an identifier of the at least one resource configuration and state information corresponding to each reference signal resource set respectively associated with each resource configuration, which is not limited and described in detail in the present disclosure. However, in practical applications, the first indication information usually includes an identifier of one resource configuration and state information corresponding to each reference signal resource set associated with the resource configuration. For the convenience of describing the present disclosure, this is taken as an example for the explanation of the relevant content in the following text, but it does not constitute a limitation. The quantity of the reference signal resource sets correspondingly associated with each resource configuration may be determined according to actual situations, which is not limited and described in detail in the present disclosure. The state information corresponding to the reference signal resource set is configured to indicate whether to perform the beam measurement on the reference signal resource set (it may specifically be the reference signals of the candidate cells in the reference signal resource set). For the introduction of the reference signal resource set and its state information, reference may be correspondingly made to the relevant introduction in other embodiments, which is omitted here.

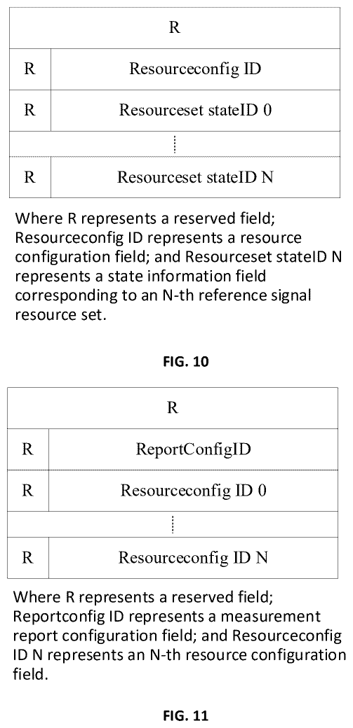

In practical applications, the first indication information in the present embodiment may be carried in third signaling for transmission. Please refer to FIG. 10, which is a schematic diagram of a signaling format according to another example. The signaling shown in FIG. 10 may include a resource configuration field (Resourceconfig ID) and a respective state information field (Resourceset stateID) for at least one reference signal resource set associated with the resource configuration field. In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The resource configuration field is used for carrying an identifier of the corresponding resource configuration, and the state information field for the reference signal resource set is used for carrying state information corresponding to the reference signal resource set. The present disclosure does not limit the quantity of the resource configuration fields, and the quantity may be determined according to actual situations. The illustration shows one resource configuration field as an example, but does not constitute a limitation. The present disclosure does not limit the quantity of the state information fields for the reference signal resource set associated with the resource configuration field, and the quantity may be determined according to actual situations. The illustration shows state information fields for N reference signal resource sets as an example, but does not constitute a limitation. N is a positive integer determined according to actual situations.

Next, the indication manner of the first indication information in the application scenario shown in FIG. 5(b) is introduced. In this application scenario, the first indication information may dynamically change/indicate a reference signal of a candidate cell for which the terminal 200 needs to perform the beam measurement.

In some embodiments, in a case where the measurement report configuration belongs to periodic reporting measurement, that is, in a case where a reporting type corresponding to the measurement report configuration is periodic reporting, the indication manner of the first indication information may have a plurality of possible implementations as follows.

In a first implementation, the first indication information may include an identifier (Reportconfig ID) for indicating the measurement report configuration and an identifier (Resourceconfig ID) of at least one resource configuration associated with the measurement report configuration. In this case, one resource configuration is correspondingly associated with one reference signal resource set (Resourceset), and one reference signal resource set includes a reference signal of one candidate cell. The identifier for the resource configuration is configured to indicate the resource configuration. For the measurement report configuration, the resource configuration, the reference signal resource set and the state information, reference may be correspondingly made to the relevant introduction in other embodiments, which is omitted here.

In practical applications, the first indication information in the present embodiment may be carried in fourth signaling for transmission. Please refer to FIG. 11, which is a schematic diagram of a signaling format according to another example. The signaling shown in FIG. 11 may include a measurement report configuration field (Reportconfig ID) and at least one resource configuration field (Resourceconfig ID). In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The measurement report configuration field is used for carrying an identifier of the measurement report configuration. The resource configuration field is used for carrying a resource configuration associated with the measurement report configuration, which may be an identifier of the resource configuration. The present disclosure does not limit the quantity of the resource configuration fields, and the quantity may be determined according to actual situations. The illustration shows N resource configuration fields (Resourceconfig ID N) as an example, but does not constitute a limitation. N is a positive integer determined according to actual situations.

In a second implementation, the first indication information may include an identifier (Reportconfig ID) for indicating the measurement report configuration and state information (Resourceconfig stateID) respectively corresponding to each resource configuration associated with the measurement report configuration. In this case, one resource configuration is correspondingly associated with one reference signal resource set (Resourceset), and one reference signal resource set includes a reference signal of one candidate cell. The state information corresponding to the resource configuration is configured to indicate whether to perform the beam measurement on the reference signal resource set (it may specifically be the reference signals of the candidate cells in the reference signal resource set) associated with the resource configuration. The present disclosure does not limit the quantity of the resource configurations, and the quantity may be determined according to actual situations. For the resource configuration, the reference signal resource set and the state information, reference may be correspondingly made to the relevant introduction in other embodiments, which is omitted here.

In practical applications, the first indication information in the present embodiment may be carried in fifth signaling for transmission. For the introduction of the fifth signaling, reference may be correspondingly made to the relevant introduction of the first signaling in the embodiment described in FIG. 8, which is omitted here.

In a third implementation, the first indication information may include an identifier (Resourceconfig ID) of one resource configuration and an identifier (Resourceset ID) of at least one reference signal resource set associated with the resource configuration. In this case, one resource configuration is correspondingly associated with the at least one reference signal resource set, and one reference signal resource set includes a reference signal of one candidate cell. The present disclosure does not limit the quantity of the resource configurations included in the first indication information. In a case where there is at least one resource configuration, the first indication information includes an identifier of the at least one resource configuration and an identifier of at least one reference signal resource set respectively associated with each resource configuration, which is not limited and described in detail in the present disclosure. However, in practical applications, the first indication information usually includes an identifier of one resource configuration and an identifier of at least one reference signal resource set associated with the resource configuration. For the convenience of describing the present disclosure, this is taken as an example for the explanation of the relevant content in the following text, but it does not constitute a limitation. The quantity of the reference signal resource sets correspondingly associated with each resource configuration may be determined according to actual situations, which is not limited and described in detail here in the present disclosure. For the resource configuration and the reference signal resource set, reference may be correspondingly made to the relevant introduction in other embodiments, which is omitted here.

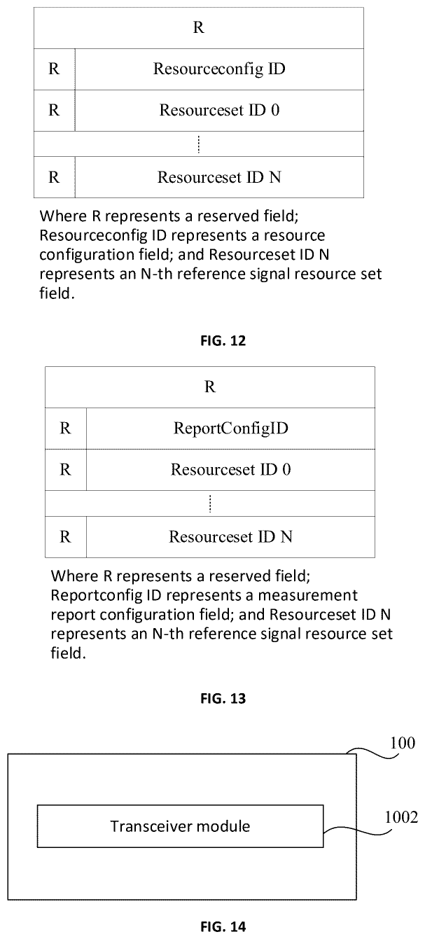

In practical applications, the first indication information in the present embodiment may be carried in sixth signaling for transmission. Please refer to FIG. 12, which is a schematic diagram of a signaling format according to another example. The signaling shown in FIG. 12 may include a resource configuration field (Resourceconfig ID) and at least one reference signal resource set field (Resourceset ID) associated with a resource configuration indicated by the resource configuration field. In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The resource configuration field is used for carrying an identifier of corresponding resource configuration. The present disclosure does not limit the quantity of the resource configuration fields. For the convenience of description, the illustration shows one resource configuration field as an example, but does not constitute a limitation. The reference signal resource set field is used for carrying an identifier of corresponding reference signal resource set. The present disclosure also does not limit the quantity of the reference signal resource set fields. The illustration shows N reference signal resource set fields as an example, but does not constitute a limitation. N is a positive integer determined according to actual situations.

In a fourth implementation, the first indication information may include an identifier (Resourceconfig ID) of one resource configuration and state information (Resourceset stateID) respectively corresponding to each reference signal resource set associated with the resource configuration. In this case, one resource configuration is correspondingly associated with at least one reference signal resource set, and one reference signal resource set includes a reference signal of one candidate cell. The present disclosure does not limit the quantity of resource configurations included in the first indication information. In a case where there is at least one resource configuration, the first indication information includes an identifier of the at least one resource configuration and state information respectively corresponding to each reference signal resource set respectively associated with each resource configuration, which is not limited and described in detail in the present disclosure. However, in practical applications, the first indication information usually includes an identifier of one resource configuration and state information respectively corresponding to each reference signal resource set associated with the resource configuration. For the convenience of describing the present disclosure, this is taken as an example for the explanation of the relevant content in the following text, but it does not constitute a limitation. The quantity of the reference signal resource sets correspondingly associated with each resource configuration may be determined according to actual situations, which is not limited and described in detail here in the present disclosure. The state information corresponding to the reference signal resource set is configured to indicate whether to perform the beam measurement on the reference signal resource set (it may specifically be the reference signals of the candidate cells in the reference signal resource set). For the introduction of the reference signal resource set and its state information, reference may be correspondingly made to the relevant introduction in other embodiments, which is omitted here.

In practical applications, the first indication information in the present embodiment may be carried in seventh signaling for transmission. For the introduction of the seventh signaling, reference may be correspondingly made to the relevant introduction of the third signaling in FIG. 10, which is omitted here.

It needs to be noted that for the introduction of the first signaling to eighth signaling, reference may further be correspondingly made to the relevant introduction in the embodiment described in FIG. 6, which is omitted here.

In some other embodiments, in a case where the measurement report configuration belongs to semi-static-reporting measurement or aperiodic reporting measurement, that is, in a case where a reporting type corresponding to the measurement report configuration is semi-static reporting or aperiodic reporting, the indication manner of the first indication information may have a plurality of possible implementations as follows.

In a first implementation, the first indication information may include an identifier (Reportconfig ID) for indicating the measurement report configuration and an identifier (Resourceset ID) of at least one reference signal resource set associated with the measurement report configuration. One reference signal resource set includes a reference signal of one candidate cell. For the measurement report configuration and the reference signal resource set, reference may be correspondingly made to the relevant introduction in other embodiments, which is omitted here.

In a second implementation, the first indication information may include an identifier (Reportconfig ID) for indicating the measurement report configuration and state information (Resourceset stateID) respectively corresponding to each reference signal resource set associated with the measurement report configuration. One reference signal resource set includes a reference signal of one candidate cell. The state information corresponding to the reference signal resource set is configured to indicate whether to perform the beam measurement on the reference signal resource set (it may specifically be the reference signals of the candidate cells in the reference signal resource set). For the introduction of the reference signal resource set and its state information, reference may be correspondingly made to the relevant introduction in other embodiments, which is omitted here.

It needs to be noted that the two implementations may be implemented and executed separately or together. In a case where the two implementations are implemented and executed together, the first indication information may include the identifier (Reportconfig ID) of the measurement report configuration, the identifier (Resourceset ID) of the at least one reference signal resource set associated with the measurement report configuration, and the state information (Resourceset stateID) respectively corresponding to each reference signal resource set associated with the measurement report configuration. For the introduction of the reference signal resource set and its state information, reference may be correspondingly made to the relevant introduction in other embodiments, which is omitted here.

In a case where the measurement report configuration belongs to semi-static reporting measurement and is reported using a physical uplink control channel (PUCCH), that is, a reporting type corresponding to the measurement report configuration is semi-static reporting and a reporting resource used is the PUCCH, the first indication information may be carried in eighth signaling. The eighth signaling is activation signaling, such as MAC CE signaling or other activation signaling. Please refer to FIG. 13, which is a schematic diagram of a signaling format according to another example. The signaling format shown in FIG. 13 corresponds to the first implementation of the present disclosure. The signaling may include a measurement report configuration field (Reportconfig ID) and at least one reference signal resource set field (Resourceset ID). In an example, the signaling may further include a reserved field (R). The present disclosure does not limit the quantity and size of the fields (such as a number of bits or bytes occupied by the fields), and the quantity and size may be determined according to the actual situation. The present disclosure is merely for illustration and does not constitute a limitation. The measurement report configuration field is used for carrying an identifier of the measurement report configuration. The reference signal resource set field is used for carrying a corresponding reference signal resource set associated with the measurement report configuration, which may be an identifier of the reference signal resource set. The present disclosure does not limit the quantity of the reference signal resource set fields, and the quantity may be determined according to actual situations. The illustration shows N reference signal resource set fields (Resourceset ID N) as an example, but does not constitute a limitation. N is a positive integer determined according to actual situations. For the signaling format corresponding to the second implementation, reference may be correspondingly made to the relevant introduction of the second signaling in the embodiment described in FIG. 9, which is omitted here.

In a case where the measurement report configuration belongs to semi-static reporting measurement and is reported using a physical uplink shared channel (PUSCH), that is, the reporting type corresponding to the measurement report configuration is semi-static reporting and the reporting resource used is the PUSCH, the first indication information may be carried in downlink control information (DCI). That is to say, the first indication information may be introduced in the triggered DCI to indicate a reference signal of a candidate cell for which the terminal 200 needs to perform the beam measurement.

In a case where the measurement report configuration belongs to aperiodic reporting measurement, that is, the reporting type corresponding to the measurement report configuration is aperiodic reporting, the first indication information may also be carried in the DCI. That is to say, in order to support the aperiodic reporting of the measurement report configuration, the first indication information may be introduced in the triggered DCI to indicate the reference signal of the candidate cell for which the terminal 200 needs to perform the beam measurement. For the indication manner of the first indication information, reference may be correspondingly made to the relevant introduction in other embodiments, which is omitted here.

It needs to be noted that in a case where an association relationship between the resource configuration and the reference signal resource set is clear, that is, in a case where the network device 100 and the terminal 200 have acquired one or more reference signal resource sets corresponding to each resource configuration in advance, the resource configuration and the reference signal resource set involved in the embodiments of the present disclosure may be replaceably used according to actual situations. For example, in the first implementation of the application scenario shown in FIG. 5(b), the first indication information may include the identifier (Reportconfig ID) of the measurement report configuration and the identifier of the at least one resource configuration associated with the measurement report configuration, where one resource configuration is correspondingly associated with one reference signal resource set. That is, the first indication information is configured to indicate the identifier (Reportconfig ID) of the measurement report configuration and at least one reference signal resource set associated with the measurement report configuration, etc., which is not excessively limited and described in the present disclosure.

By implementing the embodiment of the present disclosure, the network device 100 sends the first indication information, and the first indication information is configured to indicate the reference signal of the candidate cell for which the terminal needs to perform the beam measurement. Correspondingly, the terminal 200 receives the first indication information, and then may obtain the beam measurement result by performing the beam measurement on the reference signal of the candidate cell indicated by the first indication information. In this way, the terminal 200 can directly perform the beam measurement on the reference signals of the corresponding candidate cells indicated by the network device 100, instead of performing the beam measurement on the reference signals of all the candidate cells configured for the terminal 200. This is beneficial to save time overhead of the beam measurement and reduce measurement complexity. Meanwhile, the problems in the prior art of the large measurement time overhead and high complexity caused by the terminal performing the beam measurement on the reference signals of all the candidate cells configured for the terminal are also solved.

In an example, the present disclosure further provides a communication system (not shown). The communication system may include the network device 100 and the terminal 200. The network device 100 may perform the method for determining the reference signal of the candidate cell involving the network device in other embodiments of the present disclosure. The terminal 200 may perform the method for determining the reference signal of the candidate cell involving the terminal in other embodiments of the present disclosure.

Please refer to FIG. 14, which is a schematic structural diagram of a device for determining a reference signal of a candidate cell according to an example. The device 100 shown in FIG. 14 may be applied to the network device. The device 100 may include a transceiver module 1002.

The transceiver module 1002 is configured to send first indication information, where the first indication information is configured to indicate a reference signal of a candidate cell for which a terminal needs to perform a beam measurement.

In some embodiments, the transceiver module 1002 is further configured to send second indication information, where the second indication information is configured to indicate a measurement report configuration configured for the terminal and a reference signal of at least one candidate cell associated with the measurement report configuration.

In some embodiments, the first indication information includes an identifier for indicating the measurement report configuration, and state information corresponding to each resource configuration associated with the measurement report configuration, where one resource configuration is associated with one reference signal resource set, one reference signal resource set includes a reference signal of one candidate cell, and the state information corresponding to the resource configuration is configured to indicate whether to perform the beam measurement on the reference signal resource set associated with the resource configuration.

In some embodiments, the first indication information includes an identifier for indicating the measurement report configuration, and state information corresponding to each reference signal resource set associated with the measurement report configuration, where one reference signal resource set includes a reference signal of one candidate cell, and the state information corresponding to the reference signal resource set is configured to indicate whether to perform the beam measurement on the reference signal resource set.

In some embodiments, the first indication information includes an identifier of one resource configuration, and state information corresponding to each reference signal resource set associated with the resource configuration, where one resource configuration is associated with at least one reference signal resource set, one reference signal resource set includes a reference signal of one candidate cell, and the state information corresponding to the reference signal resource set is configured to indicate whether to perform the beam measurement on the reference signal resource set.

In some embodiments, in a case where a reporting type corresponding to the measurement report configuration is periodic reporting, the first indication information includes an identifier for indicating the measurement report configuration and an identifier of at least one resource configuration associated with the measurement report configuration, or the first indication information includes an identifier for indicating the measurement report configuration, and state information corresponding to each resource configuration associated with the measurement report configuration;
where one resource configuration is associated with one reference signal resource set, one reference signal resource set includes a reference signal of one candidate cell, and the state information corresponding to the resource configuration is configured to indicate whether to perform the beam measurement on the reference signal resource set associated with the resource configuration.

In some embodiments, in a case where a reporting type corresponding to the measurement report configuration is periodic reporting, the first indication information includes an identifier of one resource configuration and an identifier of at least one reference signal resource set associated with the resource configuration, or the first indication information includes an identifier of one resource configuration, and state information corresponding to each reference signal resource set associated with the resource configuration;
where one resource configuration is associated with at least one reference signal resource set, one reference signal resource set includes a reference signal of one candidate cell, and the state information corresponding to the reference signal resource set is configured to indicate whether to perform the beam measurement on the reference signal resource set.

In some embodiments, in a case where a reporting type corresponding to the measurement report configuration is semi-static reporting or aperiodic reporting, the first indication information includes an identifier for indicating the measurement report configuration and an identifier of at least one reference signal resource set associated with the measurement report configuration, and/or the first indication information includes an identifier for indicating the measurement report configuration, and state information corresponding to each reference signal resource set associated with the measurement report configuration, where the state information corresponding to the reference signal resource set is configured to indicate whether to perform the beam measurement on the reference signal resource set.

In some embodiments, in a case where a reporting type corresponding to the measurement report configuration is semi-static reporting and a reporting resource is a physical uplink control channel (PUCCH), the first indication information is carried in activation signaling.

In some embodiments, in a case where a reporting type corresponding to the measurement report configuration is semi-static reporting and a reporting resource is a physical uplink shared channel (PUSCH), or in a case where a reporting type corresponding to the measurement report configuration is aperiodic reporting, the first indication information is carried in downlink control information (DCI).

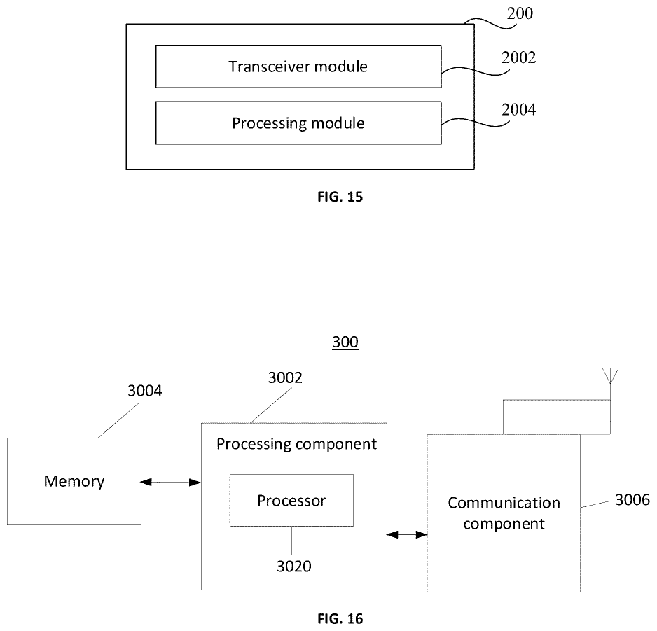

Please refer to FIG. 15, which is a schematic structural diagram of a device for determining a reference signal of a candidate cell according to another example. The device 200 shown in FIG. 15 may be applied to the terminal. The device 200 may include a transceiver module 2002 and a processing module 2004.

The transceiver module 2002 is configured to receive first indication information, where the first indication information is configured to indicate a reference signal of a candidate cell for which the terminal needs to perform a beam measurement.

The processing module 2004 is configured to obtain a beam measurement result by performing the beam measurement on the reference signal of the candidate cell indicated by the first indication information.

In some embodiments, the transceiver module 2002 is further configured to receive second indication information, where the second indication information is configured to indicate a measurement report configuration configured for the terminal and a reference signal of at least one candidate cell associated with the measurement report configuration.

In some embodiments, the first indication information includes an identifier for indicating the measurement report configuration, and state information corresponding to each resource configuration associated with the measurement report configuration, where one resource configuration is associated with one reference signal resource set, one reference signal resource set includes a reference signal of one candidate cell, and the state information corresponding to the resource configuration is configured to indicate whether to perform the beam measurement on the reference signal resource set associated with the resource configuration.

In some embodiments, the first indication information includes an identifier for indicating the measurement report configuration, and state information of each reference signal resource set associated with the measurement report configuration, where one reference signal resource set includes a reference signal of one candidate cell, and the state information corresponding to the reference signal resource set is configured to indicate whether to perform the beam measurement on the reference signal resource set.

In some embodiments, the first indication information includes an identifier of one resource configuration, and state information corresponding to each reference signal resource set associated with the resource configuration, where one resource configuration is associated with at least one reference signal resource set, one reference signal resource set includes a reference signal of one candidate cell, and the state information corresponding to the reference signal resource set is configured to indicate whether to perform the beam measurement on the reference signal resource set.

In some embodiments, in a case where a reporting type corresponding to the measurement report configuration is periodic reporting, the first indication information includes an identifier for indicating the measurement report configuration and an identifier of at least one resource configuration associated with the measurement report configuration, or the first indication information includes an identifier for indicating the measurement report configuration, and state information corresponding to each resource configuration associated with the measurement report configuration;
where one resource configuration is associated with one reference signal resource set, one reference signal resource set includes a reference signal of one candidate cell, and the state information corresponding to the resource configuration is configured to indicate whether to perform the beam measurement on the reference signal resource set associated with the resource configuration.

In some embodiments, in a case where a reporting type corresponding to the measurement report configuration is periodic reporting, the first indication information includes an identifier of one resource configuration and an identifier of at least one reference signal resource set associated with the resource configuration, or the first indication information includes an identifier of one resource configuration, and state information corresponding to each reference signal resource set associated with the resource configuration;
where one resource configuration is associated with at least one reference signal resource set, one reference signal resource set includes a reference signal of one candidate cell, and the state information corresponding to the reference signal resource set is configured to indicate whether to perform the beam measurement on the reference signal resource set.

In some embodiments, in a case where a reporting type corresponding to the measurement report configuration is semi-static reporting or aperiodic reporting, the first indication information includes an identifier for indicating the measurement report configuration and an identifier of at least one reference signal resource set associated with the measurement report configuration, and/or the first indication information includes an identifier for indicating the measurement report configuration, and state information corresponding to each reference signal resource set associated with the measurement report configuration, where the state information corresponding to the reference signal resource set is configured to indicate whether to perform the beam measurement on the reference signal resource set.

In some embodiments, in a case where a reporting type corresponding to the measurement report configuration is semi-static reporting and a reporting resource is a physical uplink control channel (PUCCH), the first indication information is carried in activation signaling.

In some embodiments, in a case where a reporting type corresponding to the measurement report configuration is semi-static reporting and a reporting resource is a physical uplink shared channel (PUSCH), or in a case where a reporting type corresponding to the measurement report configuration is aperiodic reporting, the first indication information is carried in downlink control information (DCI).

As for the device in the embodiments, the specific manners for executing operations by each module have been described in the embodiments related to the method in detail, which is not illustrated in detail here.

Please refer to FIG. 16, which is a schematic structural diagram of a communication device according to an example. The communication device 300 may be the network device 100 in a communication system or the terminal 200 in the communication system.

Referring to FIG. 16, the communication device 300 may include one or more of the following components: a processing component 3002, a memory 3004, or a communication component 3006.

The processing component 3002 may be configured to control the overall operation of the communication device 300, such as operations associated with display, telephone call, data communication, camera operations, and recording operations. The processing component 3002 may include one or more processors 3020 to execute instructions, so as to complete all or part of steps of the method for determining the reference signal of the candidate cell. In addition, the processing component 3002 may include one or more modules to facilitate interaction between the processing component 3002 and other components. For example, the processing component 3002 may include a multimedia module (not shown) to facilitate interactions between the multimedia component and the processing component 3002.

The memory 3004 is configured to store various types of data to support operations at the communication device 300. Examples of these data include instructions of any application program or method used to be operated on the communication device 300, contact data, telephone directory data, messages, pictures, videos, and the like. The memory 3004 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The communication component 3006 is configured to facilitate wired or wireless communication between the communication device 300 and other devices. The communication device 300 may access a wireless network based on a communication standard, such as Wi-Fi, 2G, 3G, 4G, 5G, 6G, narrow band Internet of thing (NB-IOT), evolved machine type communication (eMTC), or their combination. In an example, the communication component 3006 receives a broadcast signal or broadcast related information from an external broadcast management system via a broadcast channel. In an example, the communication component 3006 further includes a near-field communication (NFC) module (not shown) so as to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the communication device 300 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the method for determining the reference signal of the candidate cell.

The communication device 300 may be a stand-alone electronic device, or part of a stand-alone electronic device. For instance, the electronic device may be an integrated circuit (IC) or a chip, where the integrated circuit may be one IC or a collection of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SoC), etc. The integrated circuit or the chip can be used for executing executable instructions (or codes) to implement the method for determining the reference signal of the candidate cell. The executable instructions may be stored in the integrated circuit or the chip, or may be acquired from other apparatuses or devices. For example, the integrated circuit or the chip includes one or more processors, a memory, and an interface for communicating with other devices. The executable instructions may be stored in the one or more processors, and the method for determining the reference signal of the candidate cell may be implemented when the executable instructions are executed by the one or more processors; or, the integrated circuit or the chip may receive the executable instructions through the interface and transmit the executable instructions to the one or more processors for executing, so as to implement the method for determining the reference signal of the candidate cell.

In an example, the present disclosure further provides a computer-readable storage medium, storing computer program instructions. The computer program instructions, when executed by one or more processors, implement steps of the method for determining the reference signal of the candidate cell provided by the present disclosure. For example, the computer-readable storage medium may be a non-transitory computer-readable storage medium including instructions. For example, the computer-readable storage medium may be the memory 3004 including instructions, and the instructions may be executed by the processor 3020 of the communication device 300 to complete the method for determining the reference signal of the candidate cell. For example, the non-transitory computer-readable storage medium may be a ROM, a random access memory (RAM), a compact disc read-only memory (CD-ROM), a magnetic tape, a floppy disk, an optical data storage device, and the like.

In another example, a computer program product is further provided, containing a computer program executable by a programmable device. The computer program has a code section that, when executed by the programmable device, executes the method for determining the reference signal of the candidate cell.

As used herein, the term “processor” may refer to one processor that performs the defined functions or a plurality of processors that collectively perform defined functions, such that the execution of the individual defined functions may be divided amongst such processors.

Those skilled in the art will easily figure out other implementation solutions of the present disclosure after considering the specification and practicing the present disclosure. The present disclosure intends to cover any variant, usage, or adaptive change of the present disclosure, and these variants, usages, or adaptive changes conform to a general principle of the present disclosure and include common general knowledge or conventional technical means in the technical field not disclosed by the present disclosure. The specification and embodiments may be considered as an example merely, and a true scope and spirit of the present disclosure are indicated by the following claims.

It is to be appreciated that the present disclosure is not limited to the exact construction that has been described above and illustrated in the accompanying drawings, and that various modifications and changes may be made without departing from the scope of the present disclosure. The scope of the present disclosure is merely limited by the appended claims.

1. A method for determining a reference signal of a candidate cell, performed by a network device, the method comprising:
sending first indication information, wherein the first indication information is configured to indicate a reference signal of a candidate cell for which a terminal needs to perform a beam measurement.

2. The method according to claim 1, further comprising:
sending second indication information, wherein the second indication information is configured to indicate a measurement report configuration configured for the terminal and a reference signal of at least one candidate cell associated with the measurement report configuration.

3. The method according to claim 2, wherein the first indication information comprises an identifier for indicating the measurement report configuration, and state information corresponding to each resource configuration associated with the measurement report configuration, wherein one resource configuration is associated with one reference signal resource set, one reference signal resource set comprises a reference signal of one candidate cell, and the state information corresponding to the resource configuration is configured to indicate whether to perform the beam measurement on the reference signal resource set associated with the resource configuration.

4. The method according to claim 2, wherein the first indication information comprises an identifier for indicating the measurement report configuration, and state information corresponding to each reference signal resource set associated with the measurement report configuration, wherein one reference signal resource set comprises a reference signal of one candidate cell, and the state information corresponding to the reference signal resource set is configured to indicate whether to perform the beam measurement on the reference signal resource set.

5. The method according to claim 2, wherein the first indication information comprises an identifier of one resource configuration, and state information corresponding to each reference signal resource set associated with the resource configuration, wherein one resource configuration is associated with at least one reference signal resource set, one reference signal resource set comprises a reference signal of one candidate cell, and the state information corresponding to the reference signal resource set is configured to indicate whether to perform the beam measurement on the reference signal resource set.

6. The method according to claim 2, wherein in a case where a reporting type corresponding to the measurement report configuration is periodic reporting, the first indication information comprises an identifier for indicating the measurement report configuration and an identifier of at least one resource configuration associated with the measurement report configuration, or the first indication information comprises an identifier for indicating the measurement report configuration, and state information corresponding to each resource configuration associated with the measurement report configuration;
wherein one resource configuration is associated with one reference signal resource set, one reference signal resource set comprises a reference signal of one candidate cell, and the state information corresponding to the resource configuration is configured to indicate whether to perform the beam measurement on the reference signal resource set associated with the resource configuration.

7. The method according to claim 2, wherein in a case where a reporting type corresponding to the measurement report configuration is periodic reporting, the first indication information comprises an identifier of one resource configuration and an identifier of at least one reference signal resource set associated with the resource configuration, or the first indication information comprises an identifier of one resource configuration, and state information corresponding to each reference signal resource set associated with the resource configuration;
wherein one resource configuration is associated with at least one reference signal resource set, one reference signal resource set comprises a reference signal of one candidate cell, and the state information corresponding to the reference signal resource set is configured to indicate whether to perform the beam measurement on the reference signal resource set.

8. The method according to claim 2, wherein in a case where a reporting type corresponding to the measurement report configuration is semi-static reporting or aperiodic reporting, the first indication information comprises an identifier for indicating the measurement report configuration and an identifier of at least one reference signal resource set associated with the measurement report configuration, and/or the first indication information comprises an identifier for indicating the measurement report configuration, and state information corresponding to each reference signal resource set associated with the measurement report configuration, wherein the state information corresponding to the reference signal resource set is configured to indicate whether to perform the beam measurement on the reference signal resource set.

9. The method according to claim 8, wherein in a case where the reporting type corresponding to the measurement report configuration is the semi-static reporting and a reporting resource is a physical uplink control channel (PUCCH), the first indication information is carried in activation signaling.

10. The method according to claim 8, wherein in a case where the reporting type corresponding to the measurement report configuration is the semi-static reporting and a reporting resource is a physical uplink shared channel (PUSCH), or in a case where the reporting type corresponding to the measurement report configuration is the aperiodic reporting, the first indication information is carried in downlink control information (DCI).

11. A method for determining a reference signal of a candidate cell, performed by a terminal, the method comprising:
receiving first indication information, wherein the first indication information is configured to indicate a reference signal of a candidate cell for which the terminal needs to perform a beam measurement; and
obtaining a beam measurement result by performing the beam measurement on the reference signal of the candidate cell indicated by the first indication information.

12. The method according to claim 11, further comprising:
receiving second indication information, wherein the second indication information is configured to indicate a measurement report configuration configured for the terminal and a reference signal of at least one candidate cell associated with the measurement report configuration.

13. The method according to claim 12, wherein the first indication information comprises an identifier for indicating the measurement report configuration, and state information corresponding to each resource configuration associated with the measurement report configuration, wherein one resource configuration is associated with one reference signal resource set, one reference signal resource set comprises a reference signal of one candidate cell, and the state information corresponding to the resource configuration is configured to indicate whether to perform the beam measurement on the reference signal resource set associated with the resource configuration.

14. The method according to claim 12, wherein the first indication information comprises an identifier for indicating the measurement report configuration, and state information corresponding to each reference signal resource set associated with the measurement report configuration, wherein one reference signal resource set comprises a reference signal of one candidate cell, and the state information corresponding to the reference signal resource set is configured to indicate whether to perform the beam measurement on the reference signal resource set.

15. The method according to claim 12, wherein the first indication information comprises an identifier of one resource configuration, and state information corresponding to each reference signal resource set associated with the resource configuration, wherein one resource configuration is correspondingly associated with at least one reference signal resource set, one reference signal resource set comprises a reference signal of one candidate cell, and the state information corresponding to the reference signal resource set is configured to indicate whether to perform the beam measurement on the reference signal resource set.

16. The method according to claim 12, wherein in a case where a reporting type corresponding to the measurement report configuration is periodic reporting, the first indication information comprises an identifier for indicating the measurement report configuration and an identifier of at least one resource configuration associated with the measurement report configuration, or the first indication information comprises an identifier for indicating the measurement report configuration, and state information corresponding to each resource configuration associated with the measurement report configuration;
wherein one resource configuration is associated with one reference signal resource set, one reference signal resource set comprises a reference signal of one candidate cell, and the state information corresponding to the resource configuration is configured to indicate whether to perform the beam measurement on the reference signal resource set associated with the resource configuration.

17. The method according to claim 12, wherein in a case where a reporting type corresponding to the measurement report configuration is periodic reporting, the first indication information comprises an identifier of one resource configuration and an identifier of at least one reference signal resource set associated with the resource configuration, or the first indication information comprises an identifier of one resource configuration, and state information corresponding to each reference signal resource set associated with the resource configuration;
wherein one resource configuration is associated with at least one reference signal resource set, one reference signal resource set comprises a reference signal of one candidate cell, and the state information corresponding to the reference signal resource set is configured to indicate whether to perform the beam measurement on the reference signal resource set.

18. The method according to claim 12, wherein in a case where a reporting type corresponding to the measurement report configuration is semi-static reporting or aperiodic reporting, the first indication information comprises an identifier for indicating the measurement report configuration and an identifier of at least one reference signal resource set associated with the measurement report configuration, and/or the first indication information comprises an identifier for indicating the measurement report configuration, and state information corresponding to each reference signal resource set associated with the measurement report configuration, wherein the state information corresponding to the reference signal resource set is configured to indicate whether to perform the beam measurement on the reference signal resource set.

19-22. (canceled)

23. A network device, comprising:
one or more processors; and
a memory storing processor-executable instructions;
wherein the processor-executable instructions, when executed by the one or more processors, cause the network device to;
send first indication information, wherein the first indication information is configured to indicate a reference signal of a candidate cell for which a terminal needs to perform a beam measurement.

24. A terminal, comprising:
one or more processors; and
a memory storing processor-executable instructions;
wherein the processor-executable instructions, when executed by the one or more processors, cause the terminal to perform the method according to claim 11.

25-26. (canceled)
